(19) United States
(12) Patent Application Publication
(10) Pub. No.: US 2021/0023614 A1
(43) Pub. Date: Jan. 28, 2021

(54) CASTING FILTER

(71) Applicant: Exentis Knowledge GmbH, Stetten (CH)

(72) Inventor: Srdan Vasic, Stetten (CH)

(21) Appl. No.: 17/043,400

(22) PCT Filed: Feb. 28, 2019
(86) PCT No.: PCT/EP2019/055038

§ 371 Date: Sep. 29, 2020

(30) Foreign Application Priority Data
Mar. 29, 2018 (EP) 18165069.8
Mar. 29, 2018 (EP) 18165071.4
Mar. 29, 2018 (EP) 18165072.2
Mar. 29, 2018 (EP) 18165073.0

(51) Int. Cl. B22D 43/00; B01D 39/20; C04B 38/00

(52) U.S. Cl. CPC B22D 43/004; C04B 38/0009; B01D 39/2068

(57) ABSTRACT

Casting filter, in particular for filtering and/or purifying a metal melt, having a cell structure for passing through a metal melt and having a supporting structure for reinforcing the cell structure, the cell structure and/or the supporting structure being produced at least in sections from a ceramic material, the cell structure being formed by a plurality of cells which are delimited from one another by cell walls, wherein at least one of the cells has a constant cross-sectional shape along a flow orientation, wherein at least one of the cell walls has a wall thickness of less than 1 mm, and wherein the supporting structure is formed by at least one supporting wall which extends at least in sections between adjacent cells and whose wall thickness is greater, at least in sections, than the wall thickness of a cell wall.

### CROSS-REFERENCE TO RELATED APPLICATIONS

This application is a U.S. National stage of International Patent Application No. PCT/EP2019/055038 filed Feb. 28, 2019, which claims the benefit of priority of European Patent Application No. 18165069.8 filed Mar. 29, 2018, European Patent Application No. 18165071.4 filed Mar. 29, 2018, European Patent Application No. 18165072.2 filed Mar. 29, 2018 and European Patent Application No. 18165073.0 filed March 29, 2018 the respective disclosures of which are each incorporated herein by reference in their entireties.

### BACKGROUND

### Field of the Disclosure

The present invention refers to a casting filter, in particular for filtering and/or purifying a molten metal. The invention also refers to the use of a casting filter, a process for manufacturing metal components and a process for manufacturing a casting filter.

### Brief Description of Related Technology

It is known to use so-called casting filters when casting molten metal. Such casting filters can be inserted into the gating system of a casting mold and serve to retain exogenous and/or endogenous inclusions such as slag, foam or oxidic impurities from the casting flow. Such casting filters can, for example, consist of a metal mesh or also a ceramic structure. Ceramic filters can be designed as round hole filters, ceramic foam filters or cell filters.

Round hole filters are manufactured by a pressing process and usually have a high stability. However, due to the large wall thicknesses within the structure of the round hole filter, a high flow resistance occurs during the casting process. Ceramic foam filters ensure only moderate reproducibility due to variations in pore sizes. This can lead to different flow resistances and thus to fluctuations in casting times. The casting quality can thereby be affected.

Cell filters are usually produced by extrusion and may have cell walls with relatively thin walls. This allows a large free cross-section to be created, which is beneficial in terms of low flow resistance. Extruded cell filters, however, have only low mechanical stability, which can lead to filter breakage during casting.

### SUMMARY

Against the background described above, the task of the present invention was to specify a casting filter which simultaneously ensures a high degree of safety during the casting process with high reproducibility and relatively low flow resistance. The objective has also been to specify the use of a casting filter, a process for the production of metal components and a process for the production of a casting filter.

With regard to the casting filter, this objective has according to the present invention been solved by the subject matter of claim 1. The use of a casting filter is specified in claim 14, a process for the production of metal components in claim 15 and a process for the production of a casting filter in claim 16. Advantageous designs are subject of the dependent claims and are discussed in detail below.

A casting filter according to the invention is particularly suitable for filtering and/or cleaning a molten metal. A filter according to the invention can be designed for use in low-pressure casting processes or for use in high-pressure casting processes. In particular, a casting filter according to the invention is suitable for filtering and/or cleaning an aluminum melt, especially preferably for the casting of aluminum parts. This includes, for example, aluminum rims for automobiles.

A casting filter according to the invention has a cell structure for passing through a metal melt and a supporting structure for the reinforcement of the cell structure. The cell structure and/or the supporting structure can, at least in sections, be made of a ceramic material. Furthermore, the cell structure can be formed by a plurality of cells which are delimited from one another by cell walls, at least one of the cells having a cross-sectional shape which is constant along a flow orientation. At least one of the cell walls has a wall thickness of less than 1 mm.

According to the invention, it is further provided that the supporting structure is formed by a supporting wall which runs at least in sections between adjacent cells and whose wall thickness is greater, at least in sections, than the wall thickness of a cell wall.

The cross-sectional shape of the at least one cell, which remains constant along a flow orientation, on the one hand reduces the flow resistance. At the same time, the constant cross-sectional shape along the flow orientation favors a uniformity of the metal flow. In particular, turbulent flow can be converted into laminar flow with increased reliability, which can have a positive effect on the inflow process into the respective casting mold.

Furthermore, the low wall thickness of less than 1 mm increases the free cross-section of the cell structure, which also reduces the flow resistance. At the same time, however, the supporting structure with at least one supporting wall ensures that an overall sufficient stability is achieved. The supporting structure ensures that, despite the low wall thickness of the respective cell wall, the risk of undesired breakage of the entire casting filter or cell structure is reduced.

A casting filter according to the invention thus ensures only low flow resistance, with high reproducibility and reduced risk of material failure during a casting process.

According to a preferred design, at least one of the cell walls has a wall thickness of less than 0.75 mm, preferably less than 0.5 mm, more preferably less than 0.4 mm, even more preferably less than 0.35 mm and/or more than 0.2 mm, preferably more than 0.25 mm. Such a wall thickness can further reduce the flow resistance during a casting process and at the same time ensure sufficient stability of the cell structure. In particular, at least one of the cell walls has a wall thickness of about 0.3 mm.

Preferably, many of the cell walls have the wall thickness mentioned above. All cell walls, with the exception of the supporting walls or the cell walls at the edge of the cell structure, can be designed with the wall thickness mentioned above.

According to a further preferred design, two or more cells, preferably more than 50% of the cells, and in particular more than 75% of the cells, have the same shape. For example, several adjacent cells may have identical shapes. This can have a positive effect on the flow behavior, especially with regard to a uniform flow along the entire cell structure.

Furthermore, the cell structure can be limited by boundary cells, where the shape of at least one of the boundary cells differs from the shape of an inner cell. Thus it is possible to form all inner cells or a multiplicity of inner cells identical to each other, whereas at least some of the boundary cells have a different shape. This makes it possible to design the outer circumferential shape of the casting filter independently of the shape of the peripheral cells.

According to a further preferred design, at least one of the cells has a hexagonal cross-sectional shape, in particular a hexagonal cross-sectional shape transverse to the flow orientation. This hexagonal cross-sectional shape can, in particular, be constant along the flow orientation of the respective cell so that an identical cross-sectional shape is present both at the flow inlet and at the opposite flow outlet. Such a shape of the cell is advantageous with regard to the stability of the cell structure. At the same time, a hexagonal shape of a cell provides a relatively large free cross-sectional area, so that the flow resistance can be kept low.

A hexagonal cross-sectional shape can be an equilateral hexagonal cross-sectional shape in a particularly advantageous manner. It can also be a hexagonal cross- sectional shape with different side lengths.

According to a further design, the cell structure and/or at least one of the cells and/or cell walls has a height extending in flow orientation of less than 6 mm, in particular of less than 5 mm, and/or of more than 3 mm, preferably of more than 4 mm. In particular, the cell structure and/or at least one of the cells and/or cell walls has a height extending in flow orientation of about 4.2 mm.

It is also possible according to a preferred design that the cell structure and/or at least one of the cells and/or cell walls has a height extending in flow orientation of less than 50 mm, in particular of less than 30 mm, in particular of less than 20 mm, in particular of less than 10 mm.

A relatively large height of the cell structure or the cell walls in flow orientation also results in longer flow channels, which are particularly formed by the respective cells of the cell structure. Indeed, longer flow channels improve the filter effect. In addition, a larger height of the cell structure or the cell walls in flow orientation has a positive effect on the mechanical behavior. For this reason, cell structures are often formed with a greater height than is actually required for the respective filter effect. This can consequently also increase the flow resistance to the desired extent.

However, due to the arrangement of a supporting structure according to the invention, an excessive height of the cell structure and thus the formation of particularly long channels is no longer necessary. Rather, the design of the cell structure with a height specified above can ensure a favorable filter effect with sufficient mechanical stability.

According to a further preferred design, the supporting structure has a plurality of supporting walls, which preferably run at an angle to each other and/or from an edge area of the cell structure and an inner area of the cell structure. The supporting walls can, especially in an inner area of the cell structure, converge or merge into each other. Such a design can lead to a further improvement of the mechanical properties.

In particular, the supporting structure can divide the cell structure into a number of cell structure portions. Such cell structure portions can be cake-shaped, for example. For example, three or more cell structure portions, divided in a cake-shaped manner, can be provided, which are each limited to each other by a supporting wall. With high mechanical stability, a particularly even flow of a metal melt through the cell structure can be guaranteed in this way.

According to a further preferred design, the supporting wall can have wall sections that are angled to each other. Such a design allows the supporting wall to follow the shape of neighboring cells in an advantageous way. For example, the cells can each have a hexagonal cross-sectional shape, whereby the supporting wall can follow such a hexagonal cross-sectional shape of the respective adjacent cells or define the respective hexagonal cross-sectional shape of the adjacent cells section by section. In this way a high mechanical stability and at the same time a high degree of uniformity of the cells of the cell structure is ensured.

According to a further preferred design, the at least one supporting wall has a wall thickness of less than 0.8 mm, preferably less than 0.7 mm and/or more than 0.5 mm, preferably more than 0.6 mm. With such a wall thickness, a sufficient supporting effect for the cell structure will be guaranteed. At the same time, such a wall thickness and the associated end surface will result in an acceptable increase in the flow resistance for a molten metal in the use of the casting filter. In particular, the at least one supporting wall has a wall thickness of about 0.625 mm.

It can also be advantageous if the wall height of the supporting wall is at least in sections greater than the wall height of a cell wall. In this case, the supporting wall may have a wall section which protrudes with respect to the cell structure, in particular from an end plane of the cell structure, and/or protrudes in flow orientation with respect to at least one cell and/or cell wall. A wall section protruding in flow orientation may in particular protrude in or against a flow direction. Such a wall section may, for example, project by more than 1 mm, in particular by about 1.3 mm. The stability or the influence of the supporting structure on the stability of the cell structure can be further improved by such a protrusion of the supporting wall or by a design of the supporting wall with a protruding wall section. In particular, the protrusion in or against the flow direction provides an improved support functionality for the cell structure, which can prevent a breakage of the cell structure in the flow direction.

It may also be advantageous if the supporting wall is designed as a cell wall whose wall thickness is at least in sections greater than the wall thickness of at least one other cell wall and/or whose wall height is at least in sections greater than the wall height of at least one other cell wall. By design as a cell wall, the supporting wall can both separate two adjacent cells from each other and also define a cell section by section. In this way, the respective supporting wall can fulfill a plurality of functions, namely the formation or definition of a cell and thus a flow channel for a molten metal and at the same time the reinforcement of the entire cell structure. The reinforcement of the cell structure is achieved in particular by supporting cell walls with a smaller wall thickness.

In a further preferred way, the cell structure can be enclosed at least in sections by a frame structure, which in particular limits a flow through area for a molten metal. Such a frame structure provides additional reinforcement of the cell structure and also of the supporting structure, so that the overall stability can be further improved. In addition, a frame structure can be used to position the casting filter safely and easily within the gating system of a casting mold.

The frame structure can preferably have a circular or also a polygonal shape. Especially the outer circumferential shape and/or the inner circumferential shape of the frame structure can be circular or polygonal. In this way, the casting filter can be adapted to the respective application conditions in an advantageous way. According to the frame structure, the cell structure can also have an outer boundary with a circular or polygonal shape. The outer boundary can be formed in particular by the inner circumference of the frame structure. In this case, the inner perimeter of the frame structure can limit cells that are formed in the border area of the cell structure.

According to a further design, the cell structure can be enclosed at least in sections by a stepped frame structure. The stepped design can be provided in particular on an outer circumference of the frame structure. The frame structure is further preferably designed in a stepped manner in a flow orientation. For example, the frame structure can have a stepwise decreasing outer circumference in or against a flow direction. For this purpose, at least one step running along the outer circumference of the frame can be provided. Such a stepped design can in particular improve the hold of a casting filter within a gating system of a casting mold. In particular, such a stepped design ensures the form-fit support of the frame structure within a gating system of a casting mold, so that the secure positioning can be maintained even during the casting process. Likewise, a frame structure for enclosing the cell structure can have at least one projection or a plurality of projections on its outer circumference, via which the casting filter can be supported in flow orientation, in particular within a gating system of a casting mold.

In a preferred way, the cell structure can be enclosed at least in sections by a frame structure with a plurality of steps. By providing several steps, the support functionality in the frame structure within a gating system of a mold can be further improved.

According to a further design of the inventive casting filter, the frame structure may have at least one frame wall with a maximum wall thickness of less than 2 mm, in particular less than 1.75 mm, and/or with a minimum wall thickness of more than 1 mm, preferably more than 1.25 mm. Such a frame wall may in particular have a wall thickness of about 1.5 mm. Such a frame structure favors on the one hand a sufficient overall stability of the casting filter, but without creating a too large front surface due to the frame structure, which unnecessarily increases the flow resistance.

It may further be advantageous if the frame structure and/or the frame wall has a wall section which protrudes with respect to the cell structure, in particular from an end plane of the cell structure, and/or protrudes in flow orientation with respect to at least one of the cells and/or cell walls. A wall section protruding in flow orientation may in particular protrude in or against a flow direction. The frame structure or the respective wall section may protrude by more than 1 mm, in particular by about 1.3 mm. This has a positive effect on the overall stability of the casting filter. In particular, the projecting wall section can be connected to projecting sections of the supporting structure or the respective supporting wall, so that the stability of the supporting structure and consequently of the cell structure can be improved by designing the frame structure in this way.

According to a further preferred design, the casting filter, in particular the frame structure of the casting filter, may have an outer diameter which is greater than the height of the casting filter in flow orientation, in particular the height of the cell structure, the supporting structure and/or the frame structure in flow orientation. In particular, the outside diameter can be dimensioned to be many times larger than the height, preferably at least an integral multiple of the height. The outer diameter can therefore be at least twice as large as the height. Preferably, the outside diameter can be dimensioned at least 3 times, at least 4 times, at least 5 times, at least 6 times, at least 7 times, at least 8 times, at least 9 times or at least 10 times larger than the height.

Likewise, the outside diameter may be dimensioned by a maximum of 5 times, 6 times, 7 times, 8 times, 9 times, 10 times, 12 times, 15 times or 20 times the height.

The above ratios can also apply if the casting filter does not have a circular outer circumferential shape, but is designed with an angular outer circumferential shape, for example. In this case, a diagonal or side edge length of the casting filter extending on a vertical plane can be used as a basis for the above ratios instead of the above mentioned outside diameter. In particular, the longest diagonal or longest side edge on one height level of the casting filter can be used for this.

According to a further preferred design, the cell structure, supporting structure and/or frame structure is/are produced at least in sections by 3D printing, in particular 3D screen printing. 3D printing offers great flexibility in terms of geometric design. This is especially true with regard to shape variations along the longitudinal axis of the casting filter, such as the stepped design of the frame structure in flow orientation. At the same time, 3D screen printing production guarantees a high degree of reproducibility. In addition, the cell structure, the supporting structure or the frame structure can be produced in a cost-effective manner using 3D printing, especially 3D screen printing. 3D printing or 3D screen printing is particularly preferred for the entire casting filter.

Preferably, the cell structure, the supporting structure and/or the frame structure can be designed in one piece. All sections of the casting filter can thus be integrated into each other or be formed integrally with each other, which further improves the overall stability.

According to a further design of the casting filter, the cell structure, the supporting structure and/or the frame structure is made at least in sections of an oxide ceramic, a non-oxide ceramic and/or a composite ceramic. Such materials have sufficient mechanical properties and at the same time good filtering and cleaning properties. Preferably, an aluminum-based ceramic material, in particular containing kaolinite, mullite and/or cordierite, can also be used for the cell structure, the supporting structure and/or the frame structure. The use of an aluminum-based ceramic material improves the suitability of the casting filter for aluminum casting in particular, since the risk of inclusion of disturbing foreign atoms is reduced. Ceramic materials on aluminum basis can be formed especially as aluminum oxide, aluminum nitride or aluminum titanate.

A further independent aspect of the present invention refers to a casting filter, in particular for filtering and/or purifying a metal melt, with a cell structure made at least in sections from a ceramic material for passing through a metal melt, wherein the cell structure is formed by a plurality of cells which are delimited from one another by cell walls, wherein at least one of the cell walls has a wall thickness of less than 1 mm and wherein at least one of the cells has a hexagonal cross-sectional shape.

A further independent aspect of the present invention refers to a casting filter, in particular for filtering and/or purifying a metal melt, with a filter structure for passing through a metal melt and with a frame structure by which the filter structure is enclosed at least in sections, wherein the filter structure and/or the frame structure is at least in sections made of a ceramic material and wherein the frame structure has a projection on its outer circumference and/or is formed in stepped like manner in a flow orientation.

A further independent aspect of the present invention refers to a casting filter, in particular for filtering and/or purifying a metal melt, with a cell structure for passing through a metal melt and with a supporting structure for reinforcing the cell structure, wherein the cell structure and/or the supporting structure is produced at least in sections from a ceramic material, wherein the cell structure is formed by a plurality of cells, which are delimited from one another by cell walls, at least one of the cells having a cross-sectional shape which is constant along a flow orientation, at least one of the cell walls having a wall thickness of less than 1 mm, and the supporting structure being formed by at least one supporting wall which runs at least in sections between adjacent cells and whose wall height is greater, at least in sections, than the wall height of a cell wall.

The above described details or preferred embodiments of a casting filter also apply to the casting filters according to the further independent aspects of the present invention and also to the independent aspects described below.

Another aspect of the present invention concerns a casting device with a casting mold and a casting filter described above. Such a casting device is particularly advantageous for casting metal components, such as aluminum wheels for automobiles.

Another independent aspect of the present invention concerns the use of a casting filter, in particular a casting filter described above, for casting metal components, in particular aluminum components. Such a casting filter can be used in a particularly advantageous way for casting aluminum wheels for automobiles.

A further independent aspect of the present invention refers to a process for manufacturing a metal component, in particular an aluminum rim, in which a metal melt is passed through a casting filter described above and then solidifies within a casting mold. Such a process is particularly suitable for casting metal components, such as aluminum rims for automobiles.

Another independent aspect of the present invention concerns a process for the production of a casting filter, in particular a casting filter described above. In a process for the manufacturing of a casting filter according to the invention, a cell structure, a supporting structure and/or a frame structure is produced layer by layer in a 3D screen printing process. By the layer-by-layer production in the 3D screen printing process, a casting filter with reproducible properties can be produced at relatively low cost. The screen printing process allows a high degree of flexibility with regard to the geometric design of the casting filter, for example, variations in shape, height and/or thickness of the respective wall sections, which can be achieved by the layer-by-layer construction. For example, the layered structure of a wall or wall section can be used to create a stepped structure, which can prove advantageous when using the casting filter, especially with regard to position stability within a gating system of a casting mold. In the same way, different wall sections with different heights and/or thicknesses can be designed, whereby supporting structures for the respective cell structure can be produced in a particularly advantageous way.

Another aspect of the present invention refers to a system for the production of three-dimensional screen prints. According to the invention, such a plant is set up for the production of a casting filter described above and/or equipped with suitable stencils for the layer-by-layer production of a casting filter described above.

### BRIEF DESCRIPTION OF THE DRAWINGS

In the following, the invention is described as an example with reference to the attached figures. It is shown, schematically in each case:

FIG. 1 is a perspective view of an inventive casting filter according to an embodiment;

FIG. 2 is a top view of the casting filter of FIG. 1;

FIG. 3 is a detailed view of the casting filter according to FIG. 2;

FIG. 4 is a top view of an inventive casting filter according to an embodiment;

FIG. 5 is a side view of an inventive casting filter according to an embodiment;

FIG. 6 is a side view of a casting filter according to another embodiment;

FIG. 7 is a side view of an inventive casting filter according to an even further embodiment; and

FIG. 8 is a perspective view of an inventive casting filter according to another embodiment.

### DETAILED DESCRIPTION

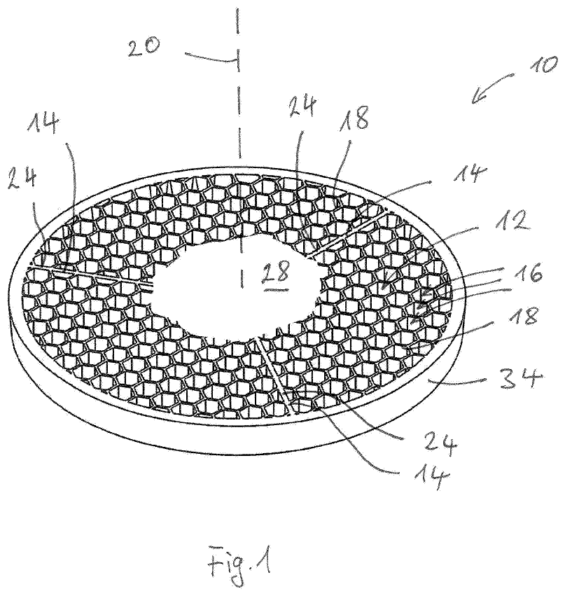

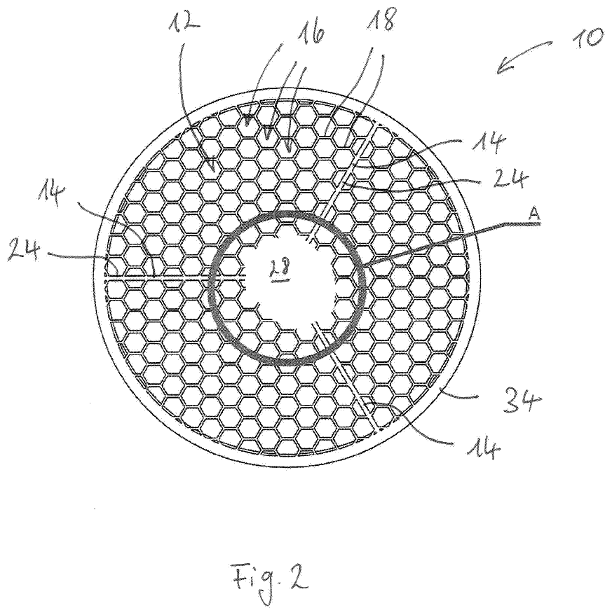

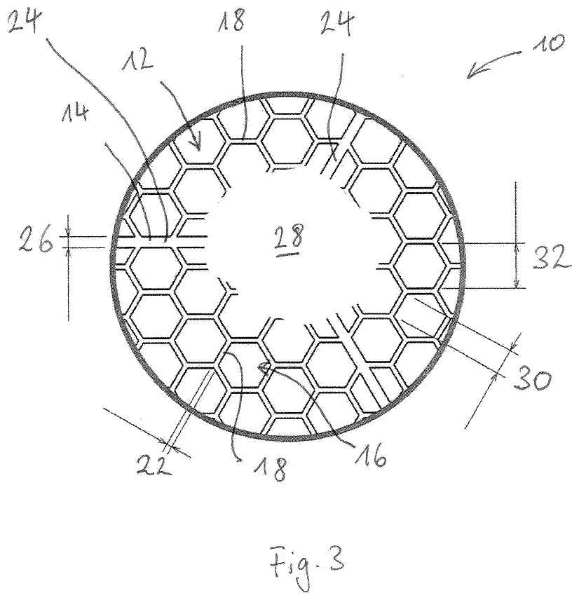

FIGS. 1 to 3 show a casting filter 10 according to a first embodiment of the invention. FIG. 1 shows a perspective view from one side of the inflow side. The upper side shown in FIG. 1 can thus be a inflow side from which a metal melt flows into the casting filter 10. A top view of the pouring filter 10 is shown in FIG. 2 and FIG. 3 shows a detailed view of the section marked “A” in FIG. 2.

The casting filter 10 has a cell structure 12 by passing through a metal melt and a supporting structure 14 to reinforce the cell structure 12. The cell structure 12 and also the supporting structure 14 can be made at least in sections from a ceramic material, in particular completely from a ceramic material. Preferably, the entire casting filter 10 can be made of a ceramic material. Furthermore, the entire casting filter 10 can be made in one piece, in particular it can consist of a single material.

The cell structure 12 is formed by a plurality of cells 16, which are delimited to each other by cell walls 18. Cells 16 form flow channels through which a molten metal can flow along a flow orientation marked with the reference sign 20. The flow orientation 20 runs along a longitudinal axis of the casting filter 10.

Cells 16 have a constant cross-sectional shape along the flow orientation 20. In the present embodiment, cells 16 have a hexagonal cross-sectional shape which remains unchanged along flow orientation 20. The respective cells 16 thus have an inflow and an outflow opening with identical cross-sectional shape.

Details of the cell structure 12 and the supporting structure 14 are shown in FIG. 3. The cell walls 18 have a wall thickness 22, which may be less than 1 mm, in particular approx. 0.3 mm. Furthermore, the supporting structure 14 may be formed by at least one supporting wall 24 which runs at least in sections between adjacent cells 16 and whose wall thickness 26 is at least in sections greater than the wall thickness 22 of a cell wall 18. The wall thickness 26 of a supporting wall may be 0.625 mm, for example. In the embodiment shown in FIGS. 1 to 3, a total of three supporting walls 24 are provided which divide the cell structure 12 into three approximately equally sized cake-shaped cell structure sections.

It can also be seen from FIGS. 1 to 3 that a majority of the cells 16 have the same shape. Only in a boundary area of the cell structure 12 boundary cells are formed, whose shape differs from that of the inner cells 16.

In FIGS. 1 to 3 a central portion 28 is hidden. In this central portion 28, different geometric configurations can be provided. For example, the supporting walls 24 in central portion 28 can merge into each other and cells 16 can be arranged in a repeating pattern up to central area 28. It is also possible to provide a supporting structure for a hold-down device in central portion 28, which is not explained in detail here.

In FIG. 3 further dimensions of cell structure 12 are designated. In particular, a length of a cell wall 18 is designated with the reference sign 30 and the distance between two opposite cells 18 of a cell 16 is designated with 32. The length 30 of a cell wall can be 1.5 mm, for example, and the distance 32 between two opposite cell walls 18 can be 2.6 mm, for example. The height of the cell structure 12 or the cell walls 18, which extends in flow orientation 20, can be 4.2 mm, for example. The height of the supporting walls 24 can be identical to the height of the cell walls 18, and it is also possible that the height of the supporting walls 24 deviates from the height of the cell walls 18.

In the embodiment shown in FIGS. 1 to 3, the supporting walls 24 run linearly through the cell structure 12. The supporting walls 24 partly border adjacent cells 16 with hexagonal cross-sectional shape. Likewise, the course of the linear supporting walls 24 according to FIGS. 1 to 3 causes cells 16 with a hexagonal cross-sectional shape to be divided by a wall section of the supporting wall 24 into two cells of equal size, each with a trapezoidal cross-sectional shape.

FIG. 4 shows a top view of a casting filter 10 according to another version of the invention. The embodiment according to FIG. 4 differs from the embodiment according to FIGS. 1 to 3 only in the design of the supporting structure 14. In the embodiment according to FIG. 4, the supporting structure 14 is also formed by a total of three supporting walls 24, although these do not run linearly through the cell structure 12, but have wall sections running at an angle to each other. By means of these wall sections running at an angle to one another, the respective supporting wall 24 can reproduce the hexagonal cross-sectional shape of the respective adjacent cells 16 or limit the respective cells 16 in a corresponding manner, without individual cells with hexagonal cross-sectional shape being divided by the supporting wall 24 into two cells with trapezoidal cross-sectional shape. This embodiment according to FIG. 4 allows a more uniform cell design.

FIGS. 1, 2 and 4 also show that the cell structure 12 is enclosed by a frame structure 34. The frame structure 34 has a circular outer circumferential shape and a circular inner circumferential shape. Other outer circumferential and inner circumferential geometries are also possible, such as polygonal inner circumferential and outer circumferential geometries.

The frame structure 34 limits a flow area for a molten metal. The frame structure 34 can have a frame wall with a maximum wall thickness of about 1.5 mm. It is possible that the frame structure 34 has a constant wall thickness along the flow orientation 20 or a changing wall thickness, especially by the formation of steps 36.

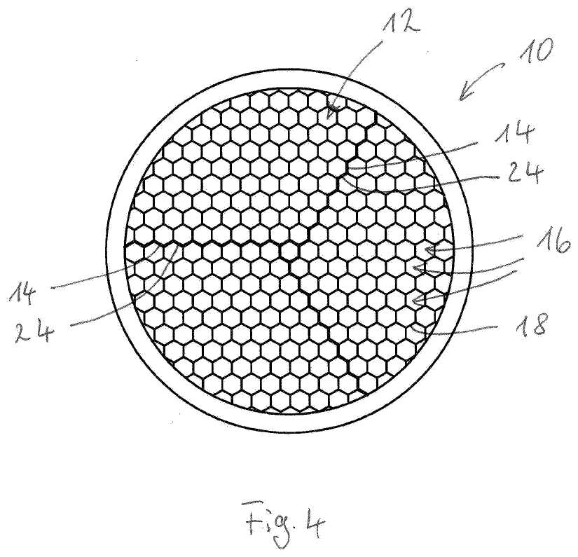

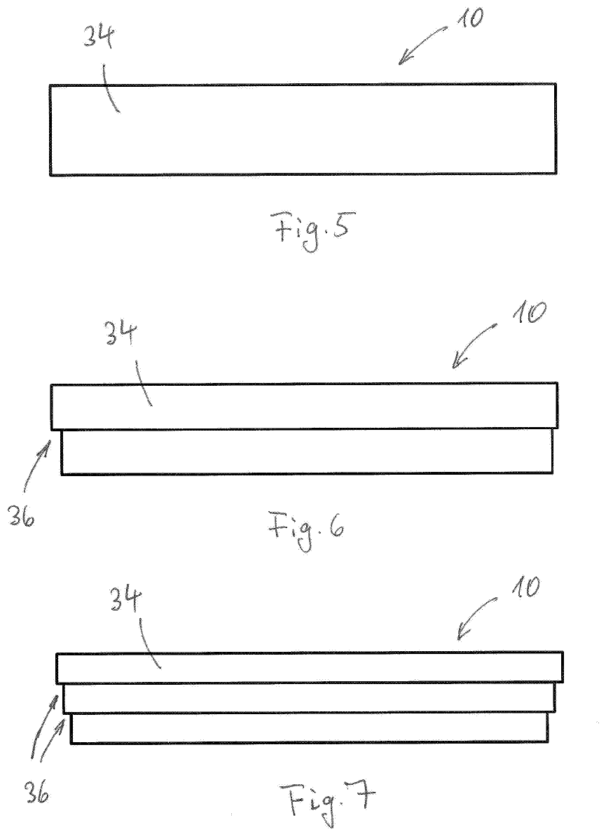

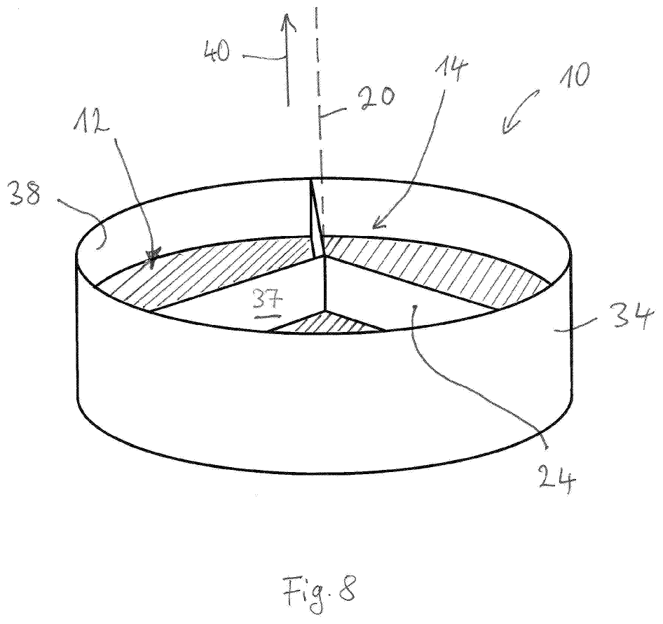

Different designs with respect to the shape of the frame structure 34 or the frame wall of the frame structure 34 are shown in the side views according to FIGS. 5 to 7. FIG. 5 shows a side view of a casting filter 10 according to the invention with a frame structure 34, which is free of steps on its outer circumference. According to FIG. 6, a frame structure 34 is provided, which is formed in a stepped like manner in a flow orientation 20 or has an outer circumference that decreases stepwise in flow direction 40. For this purpose, a step 36 running along an outer circumference of the frame is provided. By means of such a step 36, the casting filter 10 can be supported positively within a gating system of a casting mold, so that an overall higher operational safety can be achieved. According to FIG. 7, a number of steps 36 are provided, which further improves the support safety.

FIG. 8 shows a further design of a pouring filter 10. The upper side shown in FIG. 8 is an outflow side of the pouring filter 10. Hatched in FIG. 8 is the cell structure 12 or an end level of the cell structure 12. Furthermore, the supporting walls 24 of the frame structure 14 are shown schematically.

It can be seen from FIG. 8 that the supporting walls 24 of the supporting structure 14 project from the end plane of the cell structure 12. Accordingly, the supporting walls 24 have a wall section 37 which protrudes from cell structure 12, in particular from the cell plane hatched in FIG. 8. In particular, the projecting wall section 37 may have a height of approx. 1.3 mm.

The projecting design of the supporting walls 24 can also be provided for the frame structure 34. Thus, it can also be seen from FIG. 8 that the frame structure 34 has a frame wall section 38 which protrudes in the flow direction from the end plane of the cell structure 12 hatched in FIG. 8. The height of the projecting wall section of the frame structure 34 can also be approximately 1.3 mm. The flow direction is shown in FIG. 8 with the arrow designated by reference sign 40.

With a design according to FIG. 8 on the one hand a sufficient mechanical stability of the casting filter 10 can be ensured without the cell structure 12 having to have an excessive height in flow orientation 20, which would have a negative effect on the flow resistance. A casting filter 10 of this type thus has favorable filter and cleaning properties with high operational reliability.

A casting filter 10 according to the embodiments in FIGS. 1 to 8 can be manufactured in a particularly preferred way by 3D screen printing. In this way, variations along the longitudinal axis or along the flow orientation 20 can be realized in a particularly advantageous manner without incurring excessive costs. In a suitable manner, a casting filter 10 can be produced from an oxide ceramic, especially from an aluminum-based ceramic material. Such a ceramic material can be formed as aluminum oxide, aluminum nitride or aluminum titanate, for example. By using an aluminum-based ceramic material, an undesirable influence of foreign atoms can be avoided when casting an aluminum melt, for example for the production of automobile rims. In this way, the casting quality can be improved.

The forms of execution described above and the general concepts described in the introduction to the description can be combined or varied at will. For example, a casting filter according to FIG. 8 can also be designed with steps 36 according to the designs in FIG. 6 or 7, although this is not shown in detail. Likewise, a casting filter 10 can be designed according to the design in FIGS. 1 to 3 or according to the design in FIG. 4 with projecting wall sections according to FIG. 8, although this is not shown in detail.

A casting filter 10 according to the invention is particularly advantageous for casting an aluminum melt or for casting other metal melts, for example a melt of steel. In particular, a casting filter 10 is suitable for the casting of aluminum rims or other aluminum components for use in the automotive industry.

The process described above for the production of a casting filter or the process that can be carried out with an apparatus for the production of a casting filter is the Exentis 3D Mass Customization® method.

### LIST OF REFERENCE SIGNS

10 casting filter

12 cell structure

14 supporting structure

16 cells

18 cell wall

20 flow orientation

22 wall thickness of a cell wall

24 supporting wall

26 wall thickness of a supporting wall

28 central portion

30 length of a cell wall

32 distance between opposite cell walls

34 frame structure

36 step

37 protruding wall section

38 protruding wall section

40 flow direction

1. A casting filter for filtering and/or purifying a metal melt, comprising:
a cell structure for passing through a metal melt; and
a supporting structure for reinforcing the cell structure,
wherein.
the cell structure and/or the supporting structure are produced, at least in sections, from a ceramic material,
the cell structure comprises a plurality of cells which are delimited from one another by cell walls,
at least one of the plurality of cells has a constant cross-sectional shape along a flow orientation,
at least one of the cell walls has a wall thickness of less than 1 mm,
and the supporting structure is formed by at least one supporting wall which extends at least in sections between adjacent cells and whose wall thickness is greater, at least in sections, than the wall thickness of a cell wall.

2. The casting according to claim 1, wherein the at least one of the cell walls has a wall thickness of less than 0.75 mm.

3. The casting filter according to claim 1, wherein two or more cells have an identical shape.

4. The casting filter according to claim 1, wherein at least one of the plurality of cells has a hexagonal cross-sectional shape.

5. The casting filter of claim 1, wherein the cell structure and/or at least one of the plurality of cells and/or cell walls has a height extending in the flow orientation of less than 6 mm.

6. The casting filter of claim 1, wherein the supporting structure has a plurality of supporting walls, which run at an angle to one another and/or from an edge region of the cell structure into an inner region of the cell structure and/or converge towards one another in an inner region of the cell structure.

7. The casting filter of claim 1, wherein the supporting wall has a wall thickness of less than 0.8 mm.

8. The casting filter of claim 1, wherein a wall height of the supporting wall is, at least in sections, greater than a wall height of at least one of the cell wall.

9. The casting filter of claim 1, wherein the cell structure is enclosed, at least in sections, by a frame structure having a stepped design, which is arranged in the flow orientation in a stepped manner and/or which has an outer circumferential size which decreases stepwise or narrows in a flow direction and/or which has at least one step running along a frame outer circumference.

10. The casting filter according to claim 9, wherein the frame structure comprises at least one frame wall with a maximum wall thickness of less than 2 mm.

11. The casting filter according to claim 10, wherein the frame structure and/or the at least one frame wall has a wall section which protrudes from an end plane of the cell structure and/or protrudes in the flow orientation, in or against a flow direction, relative to at least one of the cells and/or cell walls and/or protrudes by more than 1 mm.

12. The casting filter of claim 1, wherein one or more of the cell structure, the supporting structure, and the frame structure are produced at least in sections by 3-D printing, and/or formed in one piece.

13. The casting filter of claim 1, wherein one or more of the cell structure, the supporting structure, and the frame structure are produced, at least in sections, from one or more an oxide ceramic, a non-oxide ceramic, a composite ceramic, and an aluminum-based ceramic material.

14. (canceled)

15. A process for producing a metal component, comprising passing a metal melt through the casting filter according to claim 1; and then solidifying the metal melt within a casting mold.

16. A method for producing the casting filter of claim 1, comprising 3-D screen printing, layer-by-layer, one or more the filter structure, the cell structure, the supporting structure, and the frame structure.

17. The casting filter of claim 1, wherein the cell structure is bounded by boundary cells and the shape of at least one of the boundary cells differs from the shape of an inner cell.

18. The casting filter of claim 4, wherein the hexagonal cross-sectional shape extends transversely to the flow orientation and/or the hexagonal cross-sectional shape is an equilateral hexagonal cross-sectional shape.

19. The casting filter of claim 1, wherein the supporting structure subdivides the cell structure into a plurality of cell structure portions in a cake-like manner.

20. The casting filter of claim 1, wherein the cell structure is enclosed, at least in sections, by a frame structure with a plurality of steps which are formed on the frame outer circumference.

21. The casting filter of claim 1, wherein the at least one supporting wall has a wall section which projects with respect to the cell structure from a terminal plane cell structure and/or projects in the flow orientation, in or against a flow direction, with respect to at least one of the cells and/or cell walls and/or projects by more than 1 mm.

22. The method of claim 15, wherein the metal component is an aluminum rim.
